(19) United States
(12) Patent Application Publication
(10) Pub. No.: US 2026/0077547 A1
(43) Pub. Date: Mar. 19, 2026

(54) FILM

(71) Applicant: INNOVIA FILMS LTD, Wigton (GB)

(72) Inventor: Jonathan HEWITT, Wigton (GB)

(73) Assignee: INNOVIA FILMS LTD, Wigton, CM (GB)

(21) Appl. No.: 19/110,048

(22) PCT Filed: Oct. 6, 2023
(86) PCT No.: PCT/EP2023/077742

§ 371 Date: Mar. 7, 2025

(30) Foreign Application Priority Data
Oct. 7, 2022 (GB) 2214779.7

(51) Int. Cl. B29C 48/08; B29C 48/00; B29C 48/21; B29C 48/36; B29C 55/00; B29C 55/08; B29K 23/00; B29K 67/00; B29K 105/04; B29K 105/16; B29L 7/00; B29L 9/00

(52) U.S. Cl. CPC B29C 48/08; B29C 48/0018; B29C 48/022; B29C 48/21; B29C 48/36; B29C 55/005; B29C 55/085; B29K 2023/16; B29K 2023/38; B29K 2067/006; B29K 2105/04; B29K 2105/16; B29K 2995/0025; B29K 2995/0049; B29K 2995/0051; B29K 2995/0097; B29L 2007/008; B29L 2009/00

(57) ABSTRACT

The present invention provides a transversely uniaxially oriented polymeric shrink film that comprises both an inorganic opacifying agent and an organic polymeric cavitating agent in a cavitated layer thereof.

This application is a National Stage application which claims priority from the international application PCT/EP2023/077742, filed Oct. 6, 2023, which claims priority from GB application No. 2214779.7 filed Oct. 7, 2022. The entirety of the aforementioned applications is incorporated herein by reference.

### FIELD

The present invention concerns a cavitated, transversely uniaxially oriented polymeric shrink film and a method of making said film.

### BACKGROUND

Films that demonstrate controlled shrinkage in a particular direction are well known in the art and have a variety of applications, including labelling or wrapping objects to provide a film that conforms to the contour of the object. This is often achieved by orienting the film at an elevated temperature, before cooling the film to quench it in its oriented state. Upon subsequent heating, the orientation stresses in the film relax, causing the film to shrink back to its original dimensions. Films that are oriented in a single direction therefore shrink on heating in the direction of orientation.

Cavitation is a well-known way of achieving a less dense film, which can be important in recycling processes, as well as imparting at least a degree of opacity to the film. This is generally achieved by including particles of either mineral cavitating agents, such as calcium carbonate, or organic cavitating agents, such as polybutylene terephthalate, in the polymeric material before orientation. Voids in the polymeric material are formed around these particles during the orientation process. In biaxially oriented films, the structure of the film is first disrupted around the particles in an initial orientation direction, and the resulting void is then expanded as the film is stretched in the subsequent orientation direction, thereby creating a cavitated layer in the film.

However, it is conventionally understood that organic polymeric cavitating agents would not be sufficient to create cavitation under uniaxial orientation, as the expansion of the voids in the second direction does not occur. High strain rates are also thought to be important when creating cavitation and as transverse uniaxial orientation using a stenter frame or tenter frame is a low strain rate process, it is therefore not sufficient to create the voids required for cavitation.

For example, WO2021127343 discloses an oriented multilayer shrink film that can be cavitated. As discussed in this document, the film may be uniaxially oriented if no voiding agent is used. However, where a voiding agent is included, the shrink film is biaxially oriented in order to create the voids.

Thus, there is a need for a transversely uniaxially orientated, cavitated polymeric shrink film, which will demonstrate the necessary shrink properties while also having a low density.

### DETAILED DESCRIPTION

According to a first aspect of the present invention, there is provided a transversely uniaxially oriented polymeric shrink film that comprises both an inorganic opacifying agent and an organic polymeric cavitating agent in a cavitated layer thereof.

It has surprisingly been found that the addition of an inorganic opacifying agent in combination with the organic polymeric cavitating agent increases the level of cavitation in the oriented film, to the extent that transverse uniaxial orientation at a low strain rate is sufficient to create a cavitated layer.

Without wishing to be bound by theory, it is thought that the inorganic opacifying agent coats the organic polymeric cavitating agent particles, thereby helping to dislocate the polymeric cavitating agent from the surrounding polymeric material and create the voids required for cavitation. Thus, sufficient voids are created even with the low strain rate of transverse direction orientation.

This is particularly surprising as it is conventionally considered important to disperse particulate additives evenly throughout the polymer, such that there is an even distribution within the resulting film. Agglomeration of particles is considered detrimental to film performance and can mean that more particles are required to achieve a similar technical effect. However, the present invention makes use of the accumulation of the inorganic opacifying agent around the organic polymeric cavitating agent in order to increase the void formation and thereby increase the ease of cavitation, such that sufficient cavitation can be created with transverse uniaxial orientation.

The shrink film of the present invention is preferably a film that shrinks predominantly in one direction, namely the transverse direction. The shrinkage in the transverse direction may be more than 3× the shrinkage in the machine direction, preferably more than 5×. The amount of shrinkage in the transverse direction can be between 40 and 90%, preferably between 50 and 85% as tested using 10 seconds exposure in a water bath at 95° C. A small degree of shrinkage or expansion (e.g. less than 10% as tested using 10 seconds exposure in a water bath at 95° C.) may be seen in the machine direction.

It should be noted that transverse uniaxial orientation does not require stretching only in the transverse direction. For example, there can be a low level of stretching in the machine direction in order to combat the expansion in the final film when it is heated for shrinkage. However, the draw ratio in the transverse direction is significantly higher than that in the machine direction. Thus, the film is considered oriented only in the transverse direction, even though a small amount of stretching and therefore a small amount of shrinkage is also seen in the machine direction.

The cavitated layer comprises a polymeric material, which may be a low melting point polymer. The term “low melting point polymer” is defined herein as a polymer having a peak melting point of less than 100° C., preferably less than 90° C. This polymer may also have an Durometer Hardness (Shore D) of less than 75, preferably less than 50 and/or a flexural modulus of less than 250 MPa, preferably less than 150 Mpa. The use of a low melting point polymer reduces the crystallinity in the cavitated layer, which generates higher shrinkage at lower temperatures for oriented structures.

Polymers having a lower melting point are often considered to be more difficult to cavitate, as they are softer and so are more difficult to create voids within. However, it has surprisingly been found that the combination of an inorganic opacifying agent and an organic polymeric cavitating agent can increase cavitation in low melting point polymers, even when the film is only transversely uniaxially oriented using a low strain rate process.

The low melting point polymer may be present in the cavitated layer at an amount of 15 to 60% by weight, preferably 20 to 50% by weight of the layer. The cavitated layer may comprise a blend of polymers, which may include the low melting point polymer in combination with a polymer having a peak melting point of more than 110° C., preferably more than 120° C. The higher melting point polymer may be present in the cavitated layer at an amount of 15 to 60% by weight, preferably 20 to 50% by weight of the layer.

The higher melting point polymer increases the ease of orientation of the cavitated layer. Thus, when a blend of low melting point polymer and higher melting point polymer is used, and providing there is sufficient miscibility, the low melting point polymer reduces the crystallinity of the higher melting point polymer as it disrupts the close chain packing and inhibits crystallisation. This also generates a broader melting range for the resulting blend. The reduction in crystallinity and the wider/lower crystal melting range generates higher shrinkage at lower temps for oriented structures. Thus, the combination of the two polymers creates an easy to orient film that generates high levels of shrinkage.

One or more of the polymers in the film may be a polyolefin, preferably a polypropylene-based polymer. The polymer having a peak melting point of less than 100° C., preferably less than 90° C., may be a polyolefin and/or the polymer having a peak melting point of more than 110° C., preferably more than 120° C., may be a polyolefin.

The low melting point polymer may be a monomeric polymer, or may be a co- or terpolymer. The low melting point polymer may comprise ethylene, propylene and/or butylene monomers. Preferably, the low melting point polymer comprises propylene monomers with one or more of ethylene and butylene monomers. The low melting point polymer may be a propylene-ethylene copolymer, a butylene-ethylene copolymer or a butylene polymer.

The polymer having a peak melting point of more than 110° C., preferably more than 120° C., may be a monomeric polymer, or may be a co- or terpolymer. The higher melting point polymer may comprise ethylene, propylene and/or butylene monomers. Preferably, the higher melting point polymer comprises propylene monomers with one or more of ethylene and butylene monomers. The higher melting point polymer may be a propylene-ethylene-butylene terpolymer. The higher melting point polymer may have a flexural modulus of between 200 and 1500 MPa, preferably between 400 and 1000 MPa.

The cavitated layer may also contain a carrier polymer that was added as part of a masterbatch for the organic polymeric cavitating agent and/or the inorganic opacifying agent. This carrier polymer may be a polyolefin, preferably polypropylene. In embodiments in which the polymeric material comprises a low melting point polymer, the carrier polymer may have a higher melting point than said polymer. The carrier polymer may be present in the cavitated layer at an amount of between 0 and 15%.

The organic polymeric cavitating agent may be any organic polymer that is able to create a cavitated polymeric film layer. This is generally achieved via incompatibility with the polymeric material of the layer. The organic polymeric cavitating agent may be a thermoplastic polymer. The organic polymeric cavitating agent may be polybutylene terephthalate, polyamide or polystyrene.

The organic polymeric cavitating agent preferably has a peak melting point below 270° C., preferably below 250° C. Thus, the organic polymeric cavitating agent preferably melts in the extruder and so is molten during the extrusion of the film. The organic polymeric cavitating agent will then form discrete domains during the extrusion process under the influence of shear, which cool to form polymeric particles within the body of the extruded and cooled sheet. These particles create the voids within the surrounding polymeric material upon stretching.

The organic polymeric cavitating agent may be present in the layer at between 1 and 15% by weight, preferably between 2 and 10% by weight of the layer.

Both the inorganic opacifying agent and the organic polymeric cavitating agent are particulate materials. The inorganic opacifying agent may have a particle size range of between 0.1 and 0.6 microns, preferably between 0.1 and 0.3 microns. The organic polymeric cavitating agent may have a particle size range of between 0.25 to 5 microns, preferably from 1 to 3 microns. All of the particles may be within this particle size range, or more than 90% of the particles may be within this particle size range.

The inorganic opacifying agent may be any inorganic agent that at least partially opacifies a polymeric layer in a film. The inorganic opacifying agent may be titanium dioxide, talc, silica, silicates, china clay (kaolin), calcium carbonate, zinc oxide, zinc sulphide and/or barium sulphate.

The inorganic opacifying agent may be present in the layer at between 1 and 15% by weight, preferably between 2 and 10% by weight of the layer.

The film may have been oriented on a stenter or tenter frame.

The transversely uniaxially oriented polymeric shrink film may have been oriented only in the transverse direction, or there may also be a low level of orientation in the machine direction. For example, the draw ratio in the transverse direction may be between 4× and 15×, preferably between 5× and 12×. The draw ratio in the machine direction may be between 1.1× and 1.5×. Thus, the draw ratio in the transverse direction may be at least 4 times greater than the draw ratio in the machine direction, preferably at least 6 times greater.

The transverse uniaxial orientation process of the present invention has a lower strain rate than the machine direction orientation step of a sequential stenter based biaxial orientation process. Thus, the film may have been oriented at a strain rate of between 0.25 and 5-s-1.

The shrink film may be a single layer film consisting of the cavitated layer comprising an inorganic opacifying agent, an organic polymeric cavitating agent and a polymeric material.

The shrink film may be a multilayer film. The film will therefore contain the cavitated layer comprising an inorganic opacifying agent and an organic polymeric cavitating agent and one or more additional layers. These additional layers may be intermediate layers, skin layers, barrier layers (including moisture, oxygen and UV barrier layers) or the like. The film may be a three layer film, a four layer film, a five layer film or a seven layer film. The film structure may be symmetrical around the core layer. The film may further comprise one or more coatings.

The additional layers may comprise a cyclo olefin copolymer or another olefinic polymer, along with any suitable additives. The additional layers may include a printable layer or a sealable layer.

The cavitated layer comprising the inorganic opacifying agent and the organic polymeric cavitating agent is preferably the core layer of the film. This layer is preferably the thickest single layer within the film structure.

The film may have a thickness of between 25 and 100 microns, preferably between 30 and 75 microns. The core layer may have a thickness of 50 to 95% of the total film thickness.

The film may further comprise additives such as antiblock, migratory slip and antistatic additives, pigments, UV stabilisers, antioxidants and other stabilisers commonly used in polymer processing. The film may also contain a level of recycled material, preferably recycled polymeric shrink film with a similar composition. The amount of recycled material in the film can be between 0 and 99% by weight, preferably between 5 and 40% by weight of the film. The recycled material may be only in the cavitated layer. The recycled material can be post-industrial waste and/or post-consumer waste.

The density of the film is preferably less than 0.93 g/cm3 when the cavitated layer contains 6% by weight inorganic opacifying agent and/or is preferably less than 0.935 g/cm3 when the cavitated layer contains 9% by weight inorganic opacifying agent. A low density is particularly important during the separation of polymeric films from other materials during recycling. Density increases on addition of inorganic opacifying agents, as these are more dense than the polymeric materials in the film. Thus, it can be a challenge to create an opaque film with the desired low density. However, the cavitation seen in the film of the present invention due to the combination of the inorganic opacifying agent and the organic polymeric cavitating agent reduces the density of the film on the addition of the opacifying agent.

The film is preferably entirely opaque, due to the presence of the opacifying agent and the cavitation.

According to a second aspect of the present invention, there is provided a method of forming a cavitated polymeric shrink film, comprising the step of transversely uniaxially orienting a polymeric material containing an inorganic opacifying agent and an organic polymeric cavitating agent.

Methods for creating shrink films are well known in the art, and involve orienting a film at an orientation temperature, before reducing the temperature to quench the film. The orientation stresses relax on subsequent heating, causing the film to shrink back to its original dimensions. The present invention therefore relates to a method of creating a shrink film that is transversely uniaxially oriented, thereby creating shrinkage predominantly in the transverse direction in the resulting film. The combination of the inorganic opacifying agent and the organic polymeric cavitating agent in the film surprisingly creates sufficient cavitation with only transverse uniaxial orientation.

The method may comprise the steps of:
a. adding an inorganic opacifying agent and an organic polymeric cavitating agent to a polymeric material;
b. extruding the polymeric material to create a film;
c. transversely uniaxially orienting the extruded film to create a cavitated film; and
d. cooling the oriented film to create a cavitated shrink film that shrinks in the transverse direction.

The inorganic opacifying agent and/or the organic polymeric cavitating agent may be added as part of a masterbatch, which may include the particles of these components in a carrier polymer. The carrier polymer may be a polyolefin, and may be polypropylene. In embodiments in which the polymeric material comprises a polymer having a peak melting point of less than 100° C., preferably less than 90° C., the carrier polymer may have a higher melting point than said polymer.

The inorganic opacifying agent and the organic polymeric cavitating agent may be added to the polymeric material in a solid form, before the mixture is heated prior to extrusion. The combination of the polymeric material, the inorganic opacifying agent and the organic polymeric cavitating agent may be mixed before and/or after heating prior to extrusion. This mixing has been found to further disperse the particles of the inorganic opacifying agent and the organic polymeric cavitating agent and can create the desired particle size. Said heating will melt the polymeric material and optionally also the organic polymeric cavitating agent. The film is then extruded.

The film may be cooled with a chilled roller and/or a water bath after extrusion and before orientation. Stretching in the machine direction can occur via a series of rollers and the film may then be annealed. Stretching in the transverse direction may be achieved by stenter stretching or tenter frame stretching. The film may be pre-heated to a temperature higher than the temperature of orientation before orientation occurs. There may be an additional annealing step after the transverse direction stretching. The film may be cooled using a chilled roller after orientation.

As discussed above, transverse uniaxial orientation may still include a low amount of stretching in the machine direction. However, the stretching in the transverse direction is significantly higher than that in the machine direction.

For example, the draw ratio in the transverse direction may be between 4× and 15×, preferably between 5× and 12×. The draw ratio in the machine direction may be between 1.1× and 1.5×. Thus, the stretching in the transverse direction may be at least 4 times greater than the stretching in the machine direction, preferably at least 6 times greater.

The extrusion and orientation may occur at elevated temperatures, above the melting temperature of the polymeric materials in the film. The extrusion may occur at a temperature above the melting point of the organic polymeric cavitating agent and the orientation may occur at a temperature below the melting point of the organic polymeric cavitating agent. The orientation temperature has to be chosen such that high levels of orientation are achieved, which will depend on the melting point of the polymeric material of the cavitated layer used. Preferably, the polymeric material has between 20 and 40% crystal melt at the orientation temperature.

The extrusion may occur at a temperature of between 18° and 275° C., preferably between 200 and 260° C., and the orientation may occur at a temperature of between 5° and 120° C., preferably between 6° and 110° C. The film may be cooled to a temperature of between 15 and 45° C., preferably between 2° and 30° C. following orientation.

One or more additional layers may be co-extruded with the layer comprising the inorganic opacifying agent and the organic polymeric cavitating agent. These additional layers may be intermediate layers, skin layers, barrier layers (including moisture, oxygen and UV barrier layers) and the like. The film may be a three layer film, a four layer film, a five layer film or a seven layer film. The film structure may be symmetrical around the core layer. Additionally or alternatively, a coating may be applied after extrusion and orientation of the film.

The method above may be used to make the shrink film described above. Thus, any feature of the first aspect applies equally to the second aspect of the present invention.

According to a third aspect of the present invention, there is provided a packaging, wrapping or label comprising the shrink film described above. Thus, any feature of the first aspect applies equally to the third aspect of the present invention.

The present invention therefore provides a low density, opaque film that readily shrinks in a single direction. Such films have various applications in packaging, wrapping and/or labelling, as they can be arranged around an article and subsequently heated to shrink and surround said article. This creates a tight fit around the article, which is aesthetically pleasing and stops the film from being easily removed from the article.

Thus, according to a fourth aspect of the present invention, there is provided an article that is packaged, wrapped or labelled with the shrink film described above. Any feature of the first aspect applies equally to the fourth aspect of the present invention.

This article can be created by loosely positioning the film around the article, before heating the film to a temperature at which it shrinks to closely surround the article.

The invention will now be more particularly described with reference to the following examples, which are not intended to be limiting on the scope of protection.

Table 1 below demonstrates the composition and density of a number of films, all of which contain the same low melting point propylene/ethylene copolymer (melting point of around 77° C.) and higher melting point propylene/butylene/ethylene terpolymer (melting point of around 128° C.). The amounts of each of these polymers are very similar in each of the films, and they only vary to accommodate the different amounts of polybutylene terephthalate (PBT) and the titanium dioxide (TiO2) that are added.

The PBT and TiO2 are added as a masterbatch containing 60% by weight of either PBT or TiO2 in polypropylene, in the amounts mentioned below. Thus, the addition of 10% by weight of the masterbatch creates a layer having 6% by weight additive, while 15% by weight masterbatch creates a layer having 9% by weight additive.

The films were all co-extruded with an intermediate layer comprising cyclo olefin copolymer and a skin layer comprising the same cyclo olefin copolymer and 1250 ppm silica antiblock at a temperature of 240° C., thereby creating a five-layer film of the same structure. The core layer made up between 70 and 80% of the thickness of the films. The films were then cooled using a roller at 25° C. and stretched to a draw ratio of 1.3× in the machine direction at 70° C. and then to a draw ratio of 9× in the transverse direction at 92° C. The films were then cooled to room temperature to create a shrink film. All of the films showed greater than 50% shrinkage in the TD at 95° C. for 10 seconds in a hot water bath.

The final column in the table below outlines the theoretical density expected if there was no cavitation, calculated using the density of the components of the film. Any reduction in density compared to this value is due to cavitation.

| | Additive | | Theoretical |
|---|---|---|---|
| Polymeric Material | Composition | | Density with |
| (% by weight of the | (% by weight of the | Density | no Cavitation |
| cavitated layer) | cavitated layer) | (g/cm³) | (g/cm³) |
| 42% terpolymer | 10% PBT masterbatch | 0.930 | 0.927 |
| 28% copolymer | | | |
| 20% recycled film | | | |
| 39% terpolymer | 15% PBT masterbatch | 0.930 | 0.935 |
| 26% copolymer | | | |
| 20% recycled film | | | |
| 33% terpolymer | 15% PBT masterbatch | 0.903 | 0.977 |
| 22% copolymer | 10% TiO₂ masterbatch | | |
| 20% recycled film | | | |
| 29% terpolymer | 15% PBT masterbatch | 0.928 | 1.000 |
| 26% copolymer | 15% TiO₂ masterbatch | | |
| 20% recycled film | | | |
| 31.25% terpolymer | 12.5% PBT masterbatch | 0.904 | 0.996 |
| 31.25% copolymer | 15% TiO₂ masterbatch | | |
| 10% recycled film | | | |

As shown by the density of the films containing only PBT compared to the theoretical densities, no cavitation is seen when only PBT is present in the film. Instead, the density corresponds to that which would be expected with no cavitation.

In contrast, when 10% by weight TiO2 masterbatch is added to the film having 15% by weight PBT masterbatch, the density decreases compared to the film with the same amount of PBT but no TiO2. The addition of TiO2 would be expected to increase the density (as it is denser than the polymers in the film) and so this decrease in density must be due to cavitation. Additionally, the observed density is much lower than the theoretical density, which further supports that the addition of TiO2 causes cavitation.

The increase in density when adding 15% by weight TiO2 masterbatch instead of 10% by weight TiO2 masterbatch is expected, due to the higher density of TiO2 compared to the polymers in the film. However, the density with 15% by weight TiO2 and 15% by weight PBT is still significantly lower than the theoretical density, thereby demonstrating that cavitation must have occurred.

Thus, the examples above demonstrate that no cavitation is seen when PBT alone is added to a transversely uniaxially oriented film. This is as expected, as the low strain rate of the transverse uniaxial orientation process would not be sufficient to create cavitation and the low melting point polymer would also act to decrease the amount of cavitation seen.

However, it has surprisingly been found that the addition of TiO2 to the film in combination with PBT creates cavitation, thereby decreasing the density of the film, even when the film is formed using transverse uniaxial stretching.

1. A transversely uniaxially oriented polymeric shrink film that comprises both an inorganic opacifying agent and an organic polymeric cavitating agent in a cavitated layer thereof.

2. The shrink film of claim 1, wherein the cavitated layer also comprises a polymer having a peak melting point of less than 100° C.

3. The shrink film of claim 2, wherein the polymer having a peak melting point of less than 100° C. is present in the cavitated layer at an amount of 15 to 60% by weight, and
optionally wherein the cavitated layer comprises a blend of said polymer with a polymer having a peak melting point of more than 110° C.

4. The shrink film claim 1, wherein one or more of the polymers in the film is a polyolefin.

5. The shrink film of claim 1, wherein the organic polymeric cavitating agent has a peak melting point below 270° C.

6. The shrink film of claim 1, wherein the organic polymeric cavitating agent is polybutylene terephthalate, polyamide or polystyrene.

7. The shrink film of claim 1, wherein the organic polymeric cavitating agent is present in the cavitated layer at between 1 and 15% by weight.

8. The shrink film of claim 1, wherein the inorganic opacifying agent has a particle size range of between 0.1 and 0.6 microns; and/or wherein the organic polymeric cavitating agent has a particle size range of between 0.25 to 5 microns.

9. The shrink film of claim 1, wherein the inorganic opacifying agent is titanium dioxide or talc.

10. The shrink film of claim 1, wherein the inorganic opacifying agent is present in the cavitated layer at between 1 and 15% by weight.

11. The shrink film of claim 1, wherein the film has been oriented in the transverse direction at least 4 times more than it has been oriented in the machine direction.

12. The shrink film of claim 1, wherein the film has been oriented at a strain rate of between 0.25 and 5 s⁻¹.

13. The shrink film of claim 1, wherein the film is a single layer film consisting of:
the cavitated layer comprising an inorganic opacifying agent and an organic polymeric cavitating agent.

14. The shrink film of claim 1, wherein the film is a multilayer film comprising the cavitated layer and one or more additional layers, and optionally wherein the cavitated layer is the core layer of the film.

15. The shrink film of claim 1, wherein the density of the film is less than 0.93 g/cm³ when the cavitated layer contains 6% by weight inorganic opacifying agent and/or wherein the density of the film is less than 0.935 g/cm³ when the cavitated layer contains 9% by weight inorganic opacifying agent.

16. A method of forming a cavitated polymeric shrink film, comprising the step of:
transversely uniaxially orienting a polymeric material containing an inorganic opacifying agent and an organic polymeric cavitating agent.

17. The method of claim 16, comprising the steps of:
(a) adding an inorganic opacifying agent and an organic polymeric cavitating agent to a polymeric material;
(b) extruding the polymeric material, the inorganic opacifying agent and the organic polymeric cavitating agent to create a film;
(c) transversely uniaxially orienting the extruded film; and
(d) cooling the oriented film to create a shrink film that shrinks in the transverse direction.

18. The method of claim 17, wherein the polymeric material, the inorganic opacifying agent and the organic polymeric cavitating agent are mixed when they are initially combined and are mixed again once the initial mixture has been heated for extrusion.

19. The method of claim 16, wherein one or more additional layers are co-extruded with the layer comprising the inorganic opacifying agent and the organic polymeric cavitating agent.

20. The method of claim 16, wherein the draw ratio in the transverse direction is at least 4 times more than that in the machine direction.

21. The method of claim 17, wherein the extrusion occurs at a temperature of between 18° and 275° C., and/or the film is cooled to a temperature of between 15 and 45° C.

22. The method of claim 16, wherein the orientation step involves stretching the film by between 4× and 15×, preferably between 5× and 12× in the transverse direction.

23. (canceled)

24. A packaging, wrapping or label comprising the shrink film of claim 1.

25. An article that is packaged, wrapped or labelled with the shrink film of claim 1.
